(19) United States
(12) Patent Application Publication
(10) Pub. No.: US 2014/0175139 A1
(43) Pub. Date: Jun. 26, 2014

(54) BEVERAGE CONTAINER HOLDER

(71) Applicant: Jose Tavares Pereira, Mississauga (CA)

(72) Inventor: Jose Tavares Pereira, Mississauga (CA)

(21) Appl. No.: 13/724,407

(22) Filed: Dec. 21, 2012

(51) Int. Cl. B60R 11/00

(52) U.S. Cl. CPC B60R 11/00
USPC 224/545

(57) ABSTRACT

A beverage container holder comprises an arcuate body pivotably mounted to a base so as to define a first pivot axis. The base is configured to be affixed to a vehicle. An annular member is pivotably mounted to the arcuate body so as to define a second pivot axis, the annular member being sized for accommodating a beverage container.

### CROSS-REFERENCE TO RELATED APPLICATION

This application claims the benefit of U.S. Provisional Application Ser. No. 61/723,377 filed on Nov. 7, 2012 and entitled “BEVERAGE CONTAINER HOLDER”, the content of which is incorporated herein by reference in its entirety.

### FIELD OF THE INVENTION

The present invention relates generally to supports and in particular, to a beverage container holder.

### BACKGROUND OF THE INVENTION

Vehicles are typically equipped with one or more beverage container holders that are fixedly-mounted to the vehicle. However, such fixedly-mounted holders are subject to forces that arise when the vehicle accelerates and decelerates during travel, which can cause contents of an open beverage container supported therein to spill. Additionally, any tilting of the vehicle relative to horizontal during travel can also cause the contents of the beverage container to spill.

Spills due to acceleration, deceleration and/or tilting of the vehicle may be reduced or eliminated by providing a pivoting holder for the beverage container. Pivoting holders for vehicles have been previously described. For example, U.S. Pat. No. 2,520,412 discloses a swinging cooker for a ship comprising a gimbal plate and stove that remain generally horizontal when the ship pitches and rolls.

U.S. Pat. No. 3,842,981 to Lambert discloses an apparatus for removably holding a liquid beverage container in a vibratory environment of a type created by a moving vehicle, such as an automobile, an airplane, or the like. The apparatus includes a housing having a base wall and a partially enclosing side wall forming an interior chamber. Mounted on the enclosing side wall in the interior chamber is a bracket which removably receives a gimbal structure. Mounted on the gimbal structure is a retaining member which has an encircling side wall sized to removably retain the beverage container. The housing is provided with a trough at its lower end in order to receive and collect any liquid spillage. The gimbal structure permits the beverage container to automatically shift its position relative to the housing to maintain a relatively vertical position and thereby compensate for any shifting of the attitude of the vehicle, and to compensate for vibratory movement imposed on or created by the vehicle.

U.S. Pat. No. 4,248,397 to Casper discloses a device for holding a cup and maintaining liquid in the cup while travelling in a vehicle. A cup holding device is carried by a support member in such a manner so as to permit rotation of the cup holding device on a first axis. A stand carries the support member in such a manner so as to permit rotation thereof on a second axis generally 90 degrees of the first axis. The stand is adapted for mounting at a desired location in the vehicle. The cup is free to act under its own inertia to maintain the liquid therein.

U.S. Pat. No. 4,819,843 to Nakayama discloses a drink container holder comprising three members: a mounting base having a mounting device for mounting within a vehicle such as an automobile, a holding framework for holding a cup, and an intermediate pivotable framework interposed between the mounting base and the holding framework. The three members are pivotably connected to one another through means of pivotable shaft bearing portions. The mounting device comprises a substantially inverted U-shaped bracket, and the mounting base has dependent bearing portions integrally suspended therefrom. A substantially U-shaped bail member is provided upon the holding framework, and the mounting base, the holding framework, and the intermediate framework are pivotable with respect to each other about two axes orthogonally arranged with respect to each other such that the three members define in effect gimbal rings for supporting the drink container.

Improvements are generally desired. It is therefore an object at least to provide a novel beverage container holder.

### SUMMARY OF THE INVENTION

In one aspect, there is provided a beverage container holder comprising: an arcuate body pivotably mounted to a base so as to define a first pivot axis, the base being configured to be affixed to a vehicle; and an annular member pivotably mounted to the arcuate body so as to define a second pivot axis, the annular member being sized for accommodating a beverage container.

The base may comprise first and second clamping members configured to cooperate for clamping to the vehicle. The first and second clamping members may be configured to cooperate for clamping to a generally cylindrical structure of the vehicle. The base may further comprise an adjustable member to which the arcuate body is pivotably mounted, the adjustable member being configured to fasten the arcuate body to the first clamping member at an angle about a third pivot axis.

The base may comprise any of: one or more suction cups, a pair of hinged clamping members, and at least one mounting plate comprising one or more fasteners.

The beverage container may further comprise a basket assembly configured for connecting to the annular member. The basket assembly may be configured for providing an additional support surface for the beverage container.

In another aspect, there is provided a kit for a beverage container holder comprising: an arcuate body configured to be pivotably mounted to a base so as to define a first pivot axis; the base, said base configured to be affixed to a vehicle; and an annular member configured to be pivotably mounted to the arcuate body so as to define a second pivot axis, the annular member being sized for accommodating a beverage container.

The base may comprise first and second clamping members configured to be removably connected to each other and being shaped to cooperate for clamping to the vehicle. The first and second clamping members may be shaped to cooperate for clamping to a generally cylindrical structure of the vehicle. The base may further comprise an adjustable member to which the arcuate body is configured to be pivotably mounted, the adjustable member being configured to fasten the arcuate body to the first clamping member at an angle about a third pivot axis.

The base may comprise any of: one or more suction cups, a pair of hinged clamping members, and at least one mounting plate comprising one or more fasteners.

The kit may further comprise a basket assembly configured to be connected to the annular member. The basket assembly may comprise a base and at least one support rod configured to removably connect the base to the annular member.

### BRIEF DESCRIPTION OF THE DRAWINGS

Embodiments will now be described more fully with reference to the accompanying drawings in which:

FIG. 1 is a perspective view of a beverage container holder;

FIG. 2 is a top plan view of the beverage container holder of FIG. 1;

FIG. 3 is a front elevated view of the beverage container holder of FIG. 1;

FIG. 4 is a side elevated view of the beverage container holder of FIG. 1;

FIG. 5 is an exploded view of the beverage container holder of FIG. 1;

FIG. 6 is a perspective view of the beverage container holder of FIG. 1, without a basket assembly;

FIG. 7 is a perspective view of another embodiment of a beverage container holder;

FIG. 8 is a top plan view of the beverage container holder of FIG. 7;

FIG. 9 is a front elevated view of the beverage container holder of FIG. 7;

FIG. 10 is a side elevated view of the beverage container holder of FIG. 7;

FIG. 11 is an exploded view of the beverage container holder of FIG. 7; and

FIG. 12 is a perspective view of the beverage container holder of FIG. 7, showing a cup supported therein.

### DETAILED DESCRIPTION OF THE EMBODIMENTS

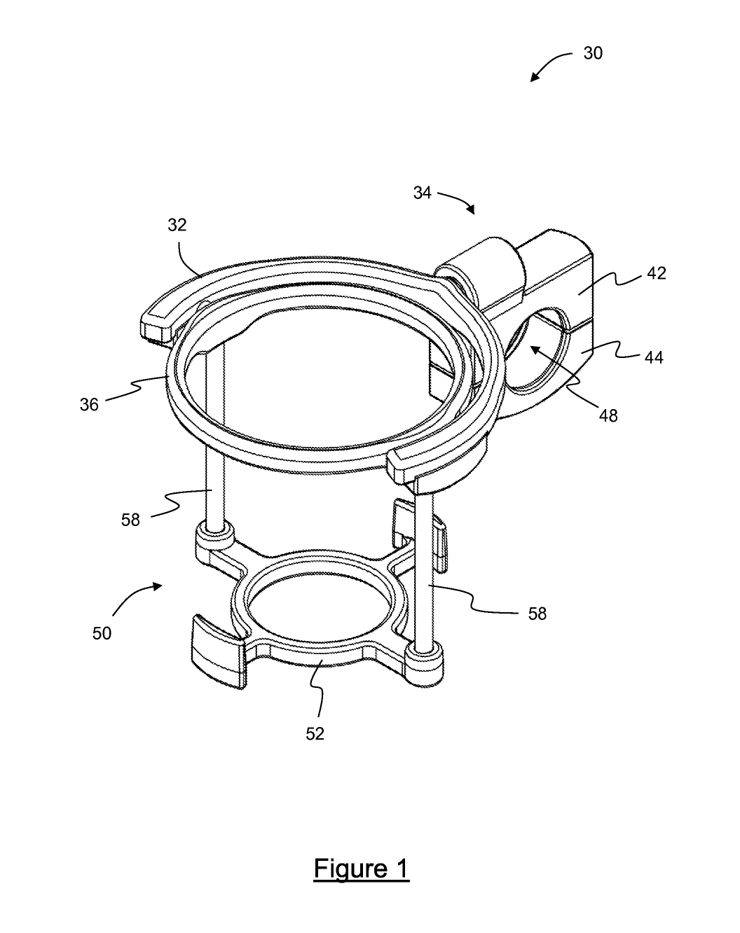

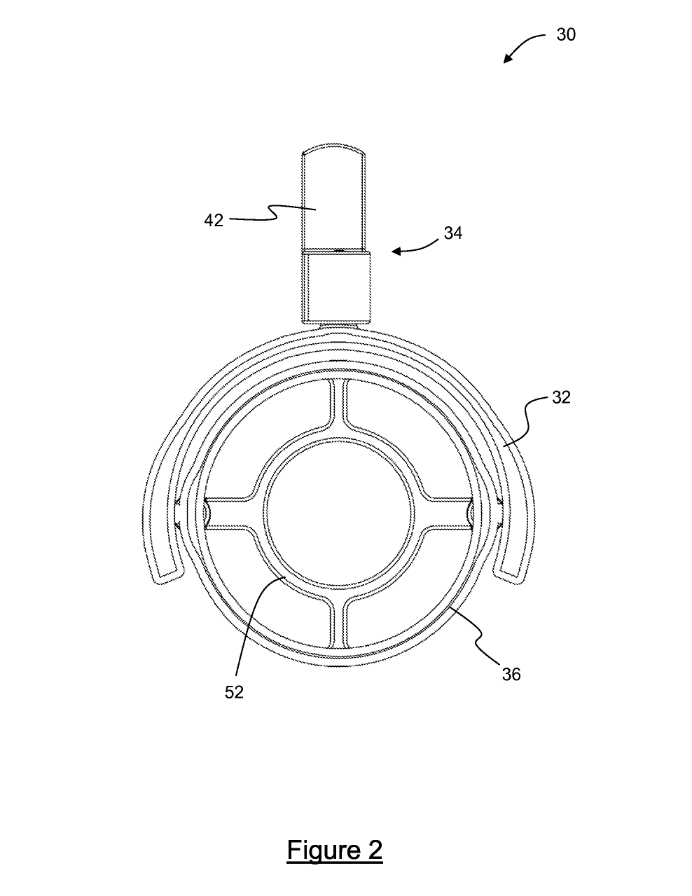

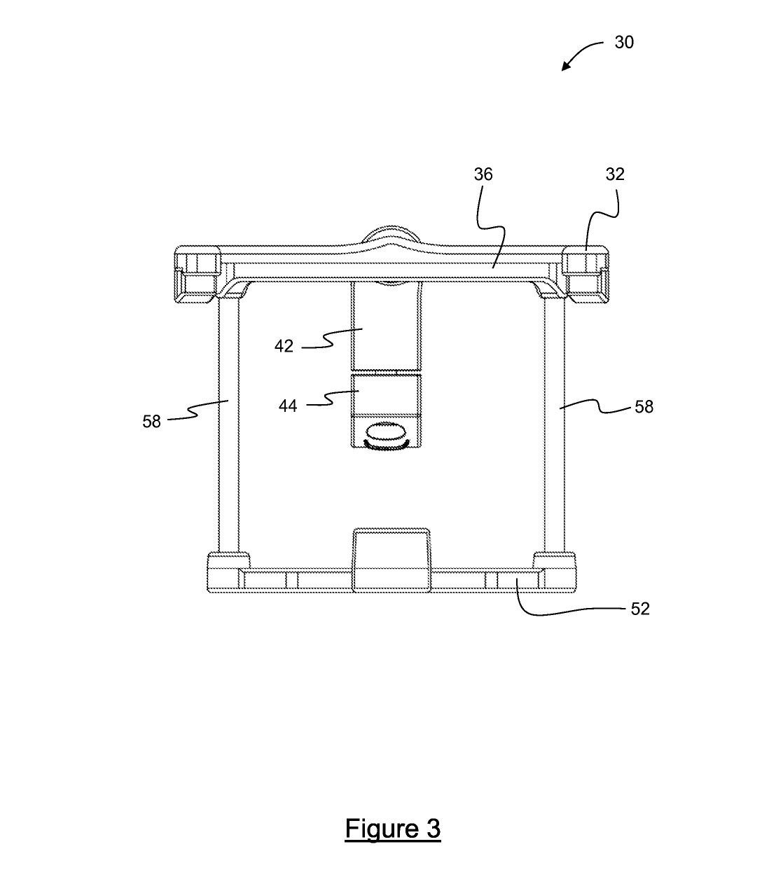

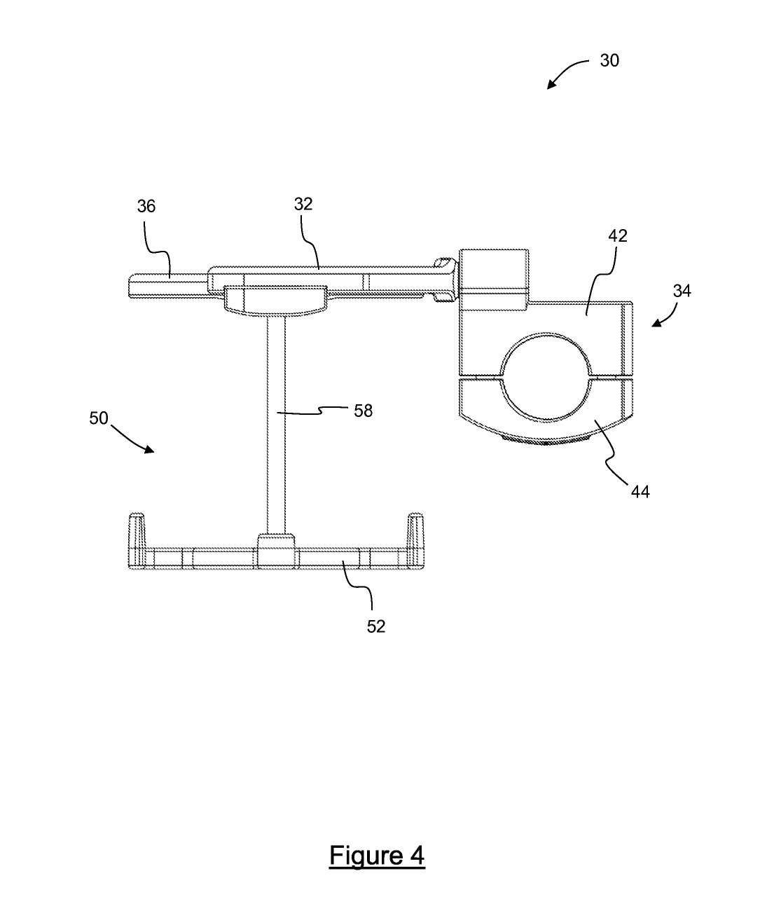

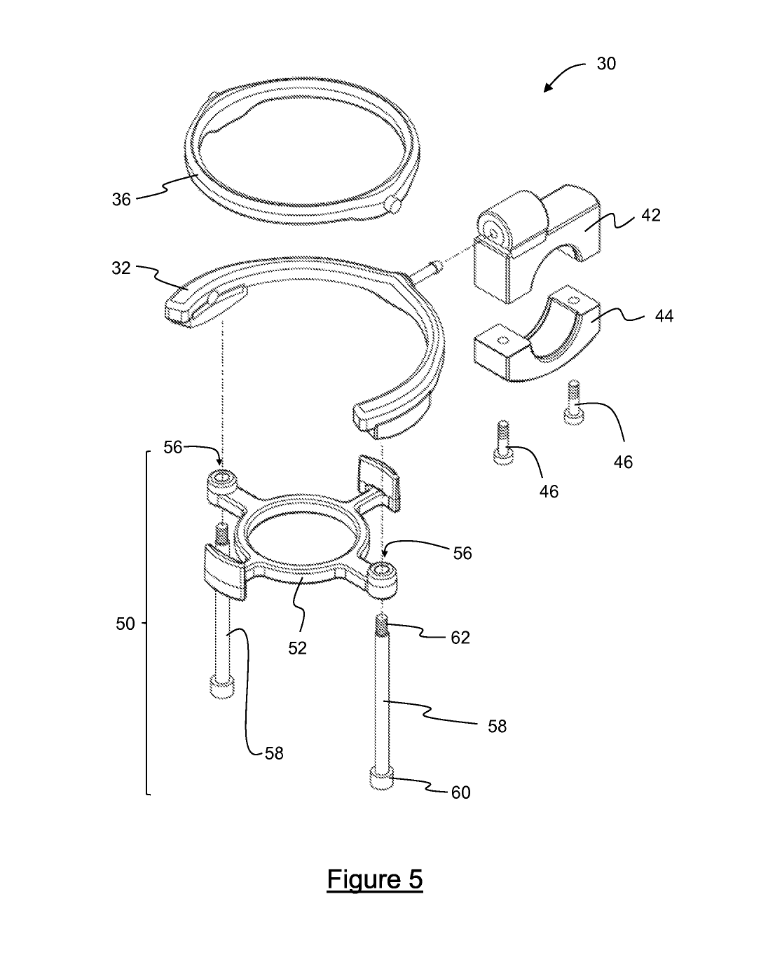

Turning now to FIGS. 1 to 5, a beverage container holder is shown and is generally indicated by reference numeral 30. Holder 30 comprises an arcuate body 32 that is pivotably mounted to a base 34 so as to define a first pivot axis. The base 34 is configured for being affixed to a vehicle. Holder 30 further comprises an annular member 36 that is pivotably mounted to the arcuate body 32 so as to define a second pivot axis. The annular member is generally sized to accommodate a beverage container (not shown), such as for example, a drinking cup, a beverage can, a drinking glass, and the like.

In this embodiment, the base 34 comprises a first clamping member 42 and a second clamping member 44 that are configured to be removably connected to each other by one or more fasteners. In the embodiment shown, the fasteners are screws 46, however it will be understood that other suitable fasteners may alternatively be used. The members 42 and 44 are shaped such that they define a generally circular aperture 48 when they are connected by the fasteners. The aperture 48 is sized so as to be generally commensurate with a generally cylindrical structure of the vehicle, such as for example a handlebar of a motorcycle, a bicycle, a watercraft, a snowmobile, and the like, or a pole affixed to or forming part of a vehicle, such as for example a boat, or any other suitable generally cylindrical structure of any vehicle.

The holder 30 further comprises a basket assembly 50 comprising a generally planar base 52. In the embodiment shown, the base 52 has two (2) apertures 56 formed therein, with each aperture 56 being sized to receive a respective support rod 58. Each support rod 58 has a head 60 having a greater diameter than the diameter of the aperture 56, and a threaded end 62 that is configured to matingly engage a threaded bore (not shown) on an underside of the annular member 36. As will be understood, when the basket assembly 50 is connected to the annular member 36, the base 52 of the basket assembly 50 provides an additional support surface for the beverage container.

During use, the assembled holder 30 is clamped to a suitable generally cylindrical structure (not shown) of a vehicle (not shown) by connecting the members 42 and 44 together around the generally cylindrical structure using the fasteners. Once clamped to the generally cylindrical structure, the holder 30 is ready to accommodate and support a beverage container (not shown), and such that the beverage container is supported by one or more of the annular member 36 and the base 52 of the basket assembly 50. As will be understood, during motion of the vehicle, contents of the opened beverage container will generally tend not to spill, due to the ability of the arcuate body 32 and the annular member 36 to pivot freely about the first and second pivot axes, respectively, so as to keep the contents of the beverage container generally level with respect to gravity.

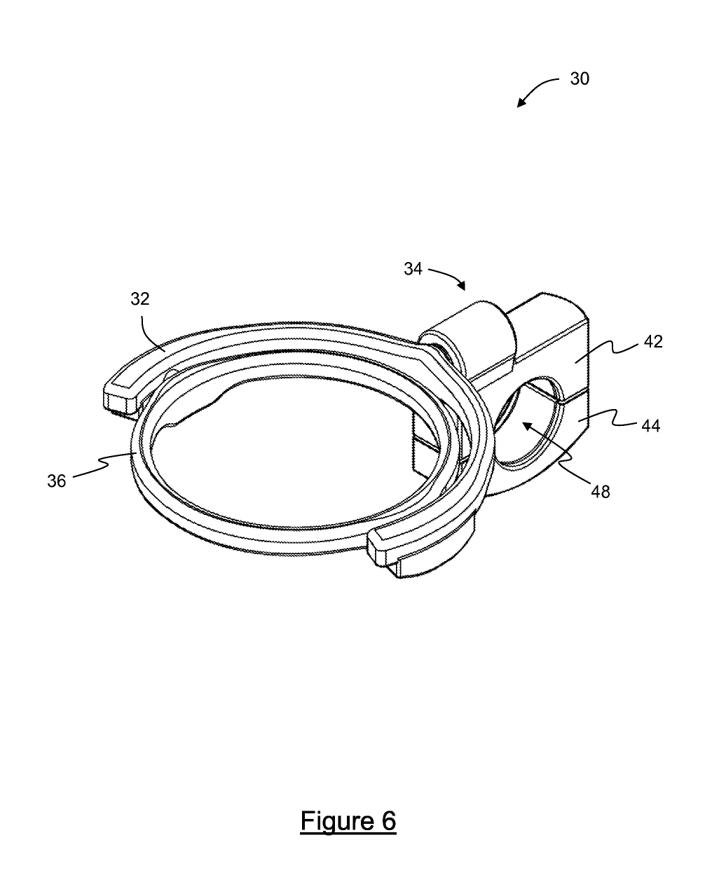

The holder 30 may also be used without the basket assembly 50. For example, FIG. 6 shows the holder 30 having the basket assembly 50 removed therefrom. During use, once clamped to the generally cylindrical structure, the assembled holder 30 with the basket assembly 50 removed therefrom is ready to accommodate and support a beverage container (not shown), and such that the beverage container is supported by the annular member 36.

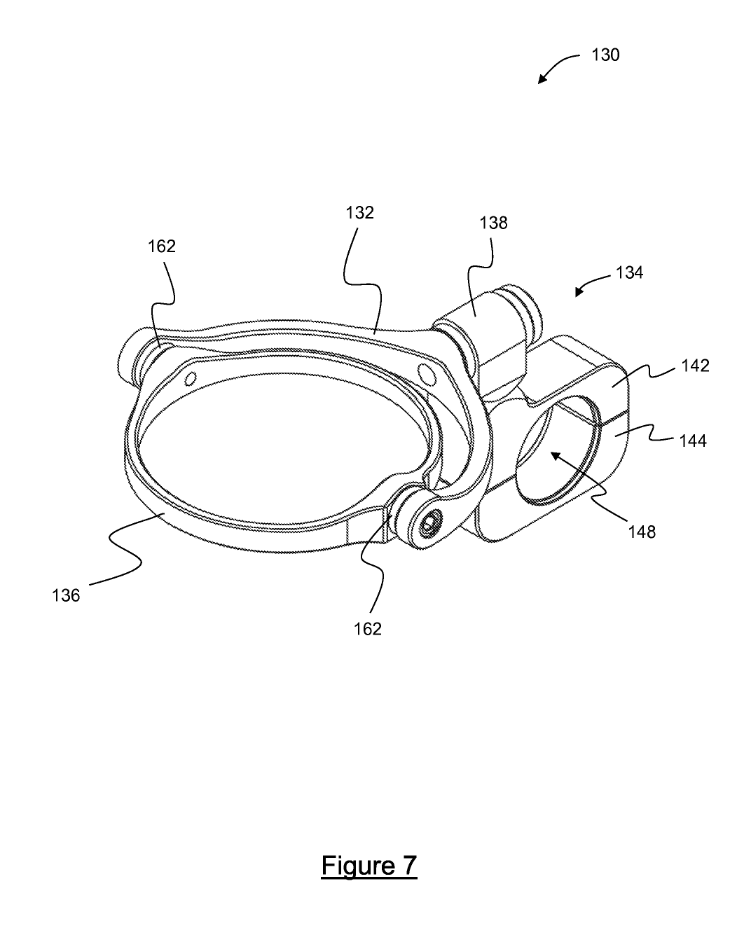

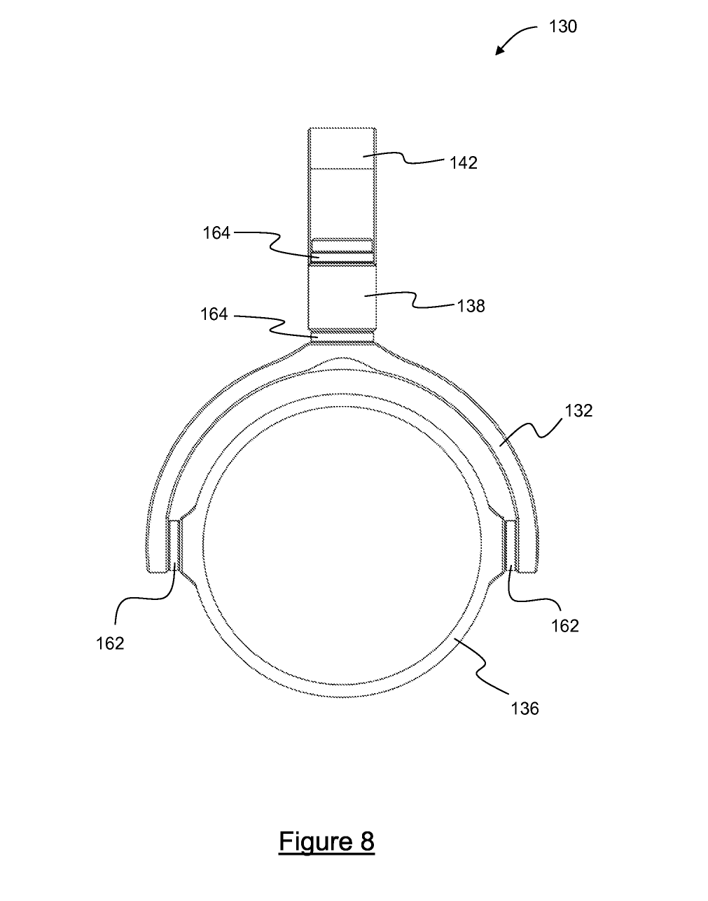

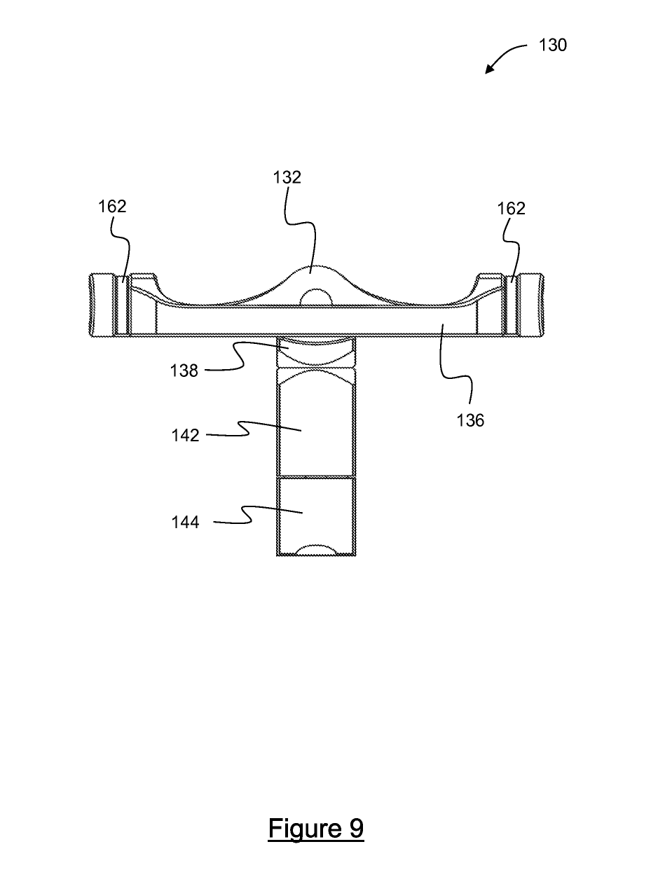

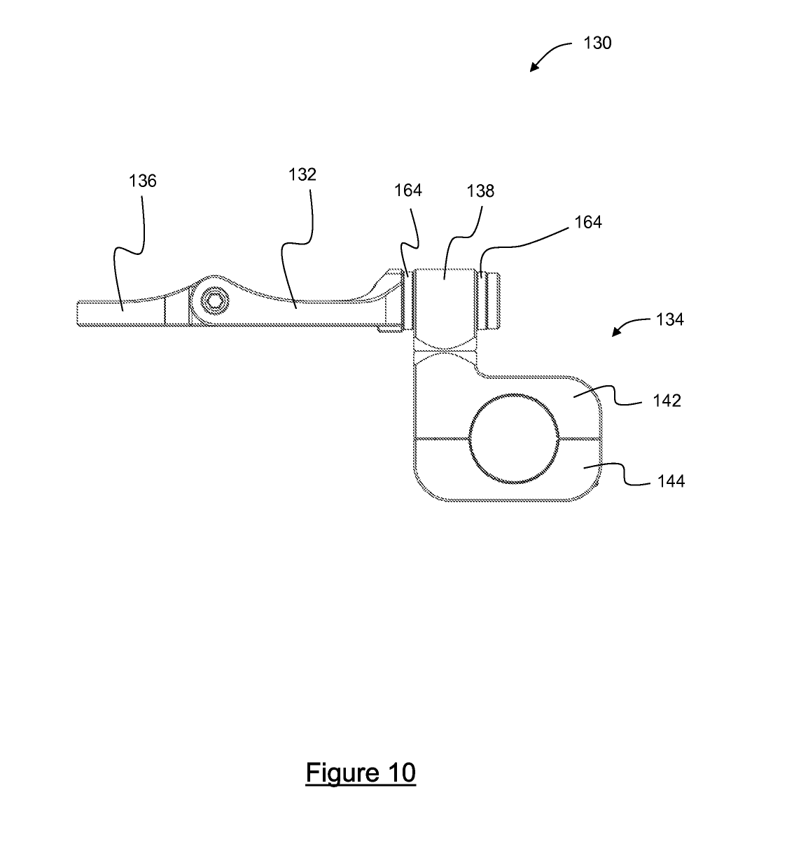

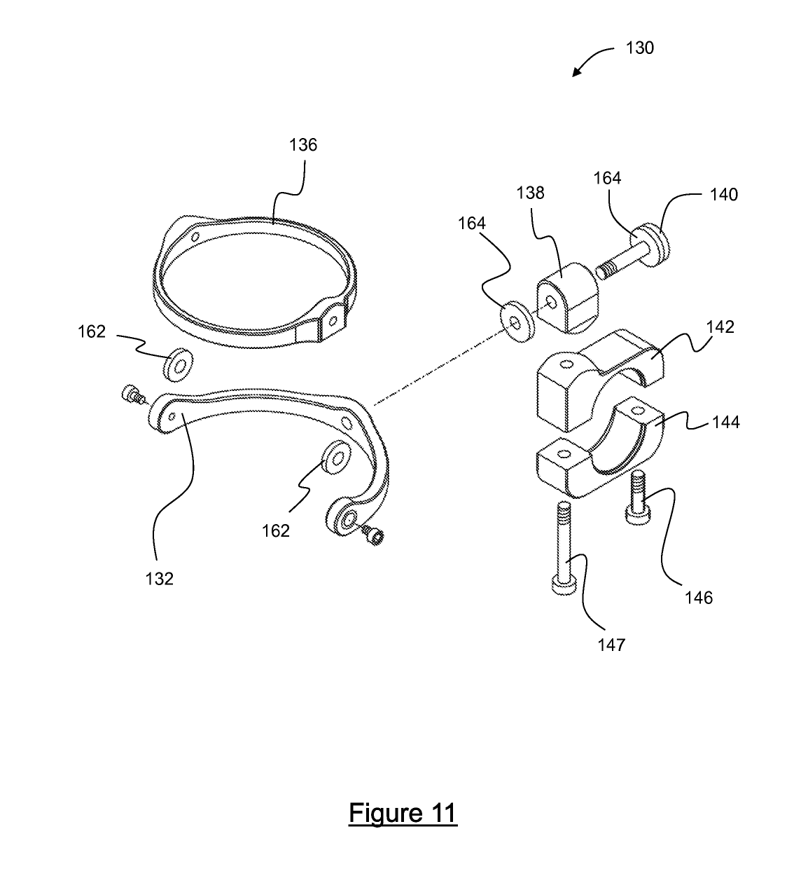

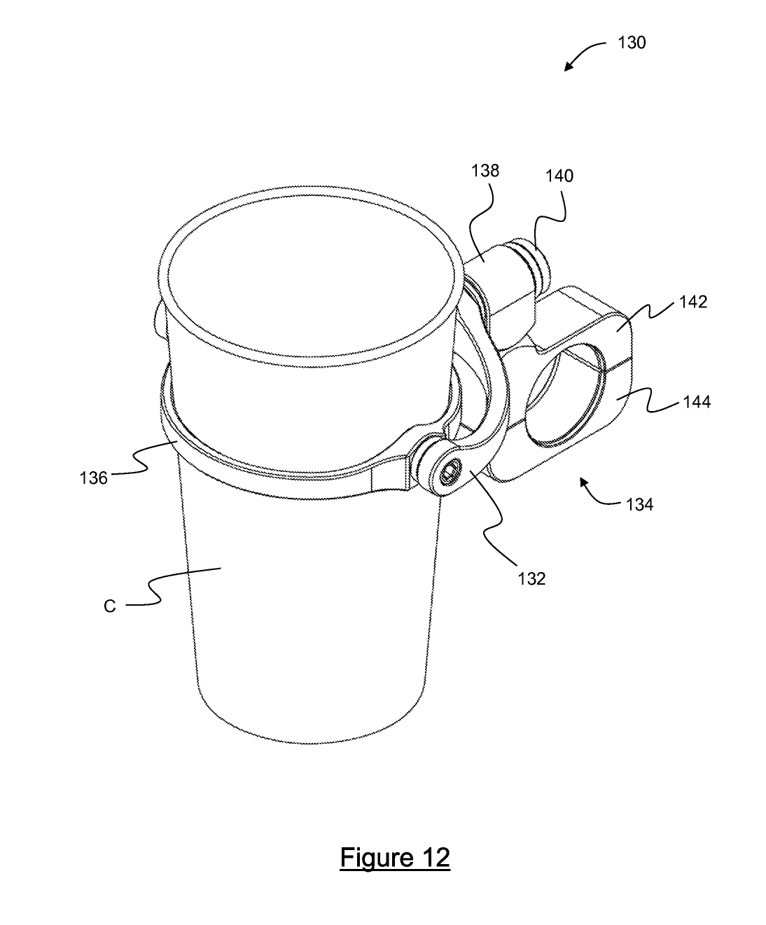

FIGS. 7 to 12 show another embodiment of a beverage container holder, which is generally indicated by reference numeral 130. Holder 130 comprises an arcuate body 132 that is pivotably mounted to a base 134 so as to define a first pivot axis. The base 134 is configured for being affixed to a vehicle. Holder 130 further comprises an annular member 136 that is pivotably mounted to the arcuate body 132 so as to define a second pivot axis. The annular member is sized to accommodate a beverage container, such as for example, a drinking cup, a beverage can, a drinking glass, and the like.

In this embodiment, the base 134 comprises an adjustable member 138 to which the arcuate body 132 is mounted. A fastening screw 140 pivotally connects the arcuate body 132 to the adjustable member 138. The base 134 further comprises a first clamping member 142 and a second clamping member 144. The second clamping member 144 is configured to be removably connected to the first clamping member 142 by one or more fasteners. In this embodiment, the fasteners are screws 146 and 147, however it will be understood that other suitable fasteners may alternatively be used. Screw 147 is sized so as to extend through the first and second clamping members 142 and 144, and into the adjustable member 138. As result, the adjustable member 138 is pivotably connected to the first clamping member 142 of the base 134, so as to define a third pivot axis. As will be understood, the screw 147 may be used to fasten the adjustable member 138 to the first clamping member 142 at a desired angle about the third pivot axis. The members 142 and 144 are shaped such that they define a generally circular aperture 148 when connected together by the fasteners. The aperture 148 is sized so as to be generally commensurate with a generally cylindrical structure of the vehicle, such as for example a handlebar of a motorcycle, a bicycle, a watercraft, a snowmobile, and the like, or a pole affixed to or forming part of a vehicle, such as for example a boat, or any other suitable generally cylindrical structure of any vehicle.

The holder 130 further comprises a plurality of bushings that are positioned between the annular member 136, the arcuate body 132, the adjustable member 138 and the fastening screw 140. In particular, the holder 130 comprises two (2) bushings 162 positioned between the annular member 136 and the arcuate body 132, a bushing 164 positioned between the arcuate body 132 and the adjustable member 138, and a bushing 164 positioned between the adjustable member 138 and the fastening screw 140. Each bushing is fabricated of a low-friction material, and has low-friction surfaces for allowing adjacent parts to pivot freely relative to each other. In this embodiment, each bushing 162 and 164 is fabricated of polyoxymethylene (POM), sometimes referred to as Delrin™, however it will be understood that other suitable low-friction materials may alternatively be used.

During use, the assembled holder 130 is clamped to a suitable generally cylindrical structure (not shown) of a vehicle (not shown) by connecting the members 142 and 144 together around the generally cylindrical structure using the fasteners. If desired, the orientation of the adjustable member 138 relative to the first clamping member 142 may be adjusted using the screw 147, so as to fasten the adjustable member 138 relative to the first clamping member 142 at a desired angle about the third pivot axis. Once clamped to the generally cylindrical structure, the holder 130 is ready to accommodate and support a beverage container C, such that the beverage container C is supported by the annular member 136. As will be understood, during motion of the vehicle, the contents of the beverage container C will generally tend not to spill, due to the ability of the arcuate body 132 and the annular member 136 to pivot freely about the first and second pivot axes, respectively, so as to keep the contents of the beverage container generally level with respect to gravity.

Although not shown, the underside of the annular member 136 comprises a pair of threaded bores (not shown) for allowing a basket assembly generally similar to basket assembly 50 described above and with reference to FIGS. 1 to 5, to be connected to the annular member 136. As will be understood, when such a basket assembly is connected to the annular member 136, the base of the basket assembly provides an additional support surface for the beverage container accommodated therein.

The present invention also contemplates a kit of parts which, when assembled, form the beverage container holder of one or more of the embodiments described above.

Although in embodiments described above, the base is configured for being affixed to a vehicle, and comprises a first clamping member and a second clamping member, in other embodiments, the base may alternatively comprise one or more other suitable structures that enable the base to be affixed to the vehicle. For example, in other embodiments, base may alternatively comprise one or more suction cups, a pair of hinged clamping members, at least one mounting plate comprising one or more fasteners such as screws and/or bolts, and the like.

Although in embodiments described above, the clamping members are configured to be clamped to a generally cylindrical structure of a vehicle, it will be understood that the clamping members are not limited to being clamped only to a generally cylindrical structure, and may alternatively be clamped to any suitable support portion of the vehicle.

Although embodiments have been described above with reference to the accompanying drawings, those of skill in the art will appreciate that variations and modifications may be made without departing from the scope thereof as defined by the appended claims.

What is claimed is:

1. A beverage container holder comprising:
an arcuate body pivotably mounted to a base so as to define a first pivot axis, the base being configured to be affixed to a vehicle; and
an annular member pivotably mounted to the arcuate body so as to define a second pivot axis, the annular member being sized for accommodating a beverage container.

2. The beverage container holder of claim 1, wherein the base comprises first and second clamping members configured to cooperate for clamping to the vehicle.

3. The beverage container holder of claim 2, wherein the first and second clamping members are configured to cooperate for clamping to a generally cylindrical structure of the vehicle.

4. The beverage container holder of claim 2, wherein the base further comprises an adjustable member to which the arcuate body is pivotably mounted, the adjustable member being configured to fasten the arcuate body to the first clamping member at an angle about a third pivot axis.

5. The beverage container holder of claim 1, wherein the base comprises any of: one or more suction cups, a pair of hinged clamping members, and at least one mounting plate comprising one or more fasteners.

6. The beverage container holder of claim 1, further comprising a basket assembly configured for connecting to the annular member.

7. The beverage container holder of claim 6, wherein the basket assembly is configured for providing an additional support surface for the beverage container.

8. A kit for a beverage container holder comprising:
an arcuate body configured to be pivotably mounted to a base so as to define a first pivot axis;
the base, said base configured to be affixed to a vehicle; and
an annular member configured to be pivotably mounted to the arcuate body so as to define a second pivot axis, the annular member being sized for accommodating a beverage container.

9. The kit of claim 8, wherein the base comprises first and second clamping members configured to be removably connected to each other and being shaped to cooperate for clamping to the vehicle.

10. The kit of claim 9, wherein said first and second clamping members are shaped to cooperate for clamping to a generally cylindrical structure of the vehicle.

11. The kit of claim 9, wherein the base further comprises an adjustable member to which the arcuate body is configured to be pivotably mounted, the adjustable member being configured to fasten the arcuate body to the first clamping member at an angle about a third pivot axis.

12. The kit of claim 8, wherein the base comprises any of: one or more suction cups, a pair of hinged clamping members, and at least one mounting plate comprising one or more fasteners.

13. The kit of claim 8, further comprising a basket assembly configured to be connected to the annular member.

14. The kit of claim 13, wherein the basket assembly comprises a base and at least one support rod configured to removably connect the base to the annular member.
